(19) United States
(12) Patent Application Publication
(10) Pub. No.: US 2006/0234565 A1
(43) Pub. Date: Oct. 19, 2006

(54) LEAD HOLDING APPARATUS FOR AN ELECTRONIC DEVICE

(76) Inventors: Kuan-Hong Hsieh, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,671

(22) Filed: Dec. 1, 2005

(30) Foreign Application Priority Data
Apr. 15, 2005 (CN) 200520057329.8

(51) Int. Cl. H01R 9/22

(52) U.S. Cl. 439/719

(57) ABSTRACT

A lead holding apparatus is provided. The lead holding apparatus includes a cavity (70) to hold one or more leads, a groove (40) on a side of the cavity to prevent the leads from loosening and to hold the leads in an ordered manner, and a baffle board (50) above the cavity to hold the leads in the cavity. The lead holding apparatus can be mounted on an electronic device or integrally formed in the device.

### FIELD OF THE INVENTION

The present invention relates to lead holding apparatuses, and particularly to a lead holding apparatus typically used in an electronic device.

### DESCRIPTION OF RELATED ART

In general, electronic devices such as computers are connected to one or more associated external devices such as monitors and keyboards through various lead connections. For example, a personal computer is connected to an external power supply through a power lead in order to obtain primary power, and is connected to an audio amplifier in order to provide good acoustics. Typically, a plurality of leads are connected between the electronic device and the external devices. If the leads are arranged in a disorderly or unsystematic way, they can be difficult to deal with and maintain. It is preferable that the leads are trimmed and arranged in order, thereby conveniently distinguishing one lead from another. Commonly, lead ties are used to bind the leads together and keep the leads arranged in an orderly manner. However, when the leads are enclosed by lead ties, it can be difficult to distinguish the leads and readily see the connection relationships between the various devices. Maintenance workers may have to remove the lead ties so as to distinguish among the leads. Further, after finishing maintenance, the workers have to use new lead ties to bind the leads again. These requirements are not only time-consuming, but also waste materials.

Therefore, what is needed is a lead holding apparatus which easily and conveniently holds leads therein.

### SUMMARY OF INVENTION

A lead holding apparatus is provided herein. The lead holding apparatus includes a baffle board and a cavity so that the leads can be received therein. Further, the lead holding apparatus provides a groove on one side thereof adjacent the cavity. The lead holding apparatus can be mounted on a device or integrally formed in the device.

Further features and advantages will be provided or will become apparent in the course of the following detailed description.

### BRIEF DESCRIPTION OF DRAWINGS

FIG. 1 is a schematic, isometric view of a lead holding apparatus, in accordance with a preferred embodiment of the present invention.

FIG. 2 is similar to FIG. 1, but showing two leads held in the lead holding apparatus.

### DETAILED DESCRIPTION

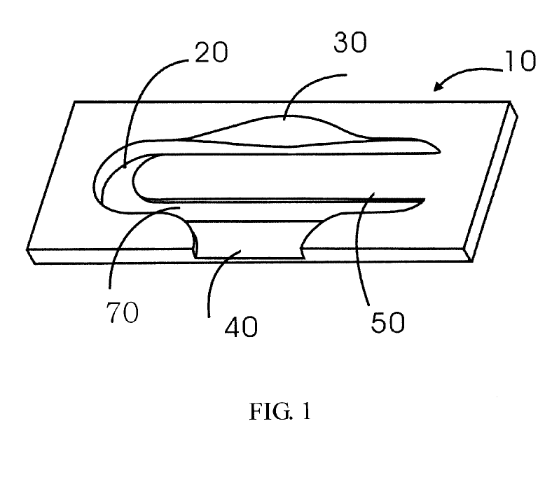

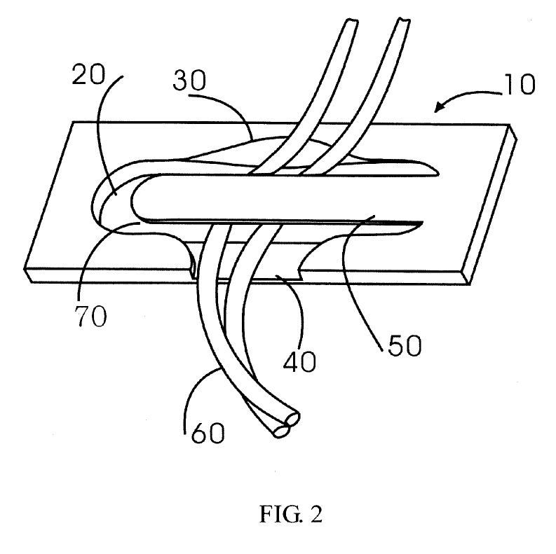

Referring to FIG. 1, a lead holding apparatus in accordance with a preferred embodiment of the present invention is shown. In a typical application of the preferred embodiment, the lead holding apparatus 10 is on a chassis of the display device. The apparatus 10 can be on a bracket or other place of the display device, and can be mounted on or integrally formed in the device. The apparatus 10 includes a baffle board 50 and a cavity 70 below the baffle board 50. One end of the baffle board 50 is attached to an end portion of a main body of the apparatus 10. An opposite free end of the baffle board 50 opposes an opposite end portion of the main body of the apparatus 10 across an entrance 20. Leads 60 (see FIG. 2) can be passed through the entrance 20 and received and held in the cavity 70. Additionally, the apparatus 10 provides a sliding chute 30 adjacent the cavity 70, and a groove 40 adjacent the cavity 70 opposite the chute 30.

The sliding chute 30 and the groove 40 are respectively configured with a gradient so that the leads 60 can be easily and smoothly held in the cavity 70 without being unduly bent. Additionally, with the aid of the baffle board 50, the leads 60 can be retained and arranged parallel to each other in the cavity 70. Further, either or both of the sliding chute 30 and the groove 40 can be sized or configured according to the diameters and quantity of the leads 60 needing to be held in the cavity 70.

FIG. 2 shows the apparatus 10 holding two leads 60. In use, each lead 60 can be bent and passed through the entrance 20, and then slid and received in the cavity 70. After being received, the leads 60 can be restrained and arranged parallel to each other in an alignment according to the sizes of the sliding chute 30 and the groove 40.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A lead holding apparatus, the lead holding apparatus comprising:
a cavity for receiving one or more leads;
a baffle board above the cavity;
an entrance adjacent one end of the baffle board for letting the leads pass therethrough to the cavity; and
a groove adjacent the cavity for cooperating with the cavity and the baffle board to hold the leads in place.

2. The lead holding apparatus of claim 1, further comprising a sliding chute adjacent the cavity opposite the groove.

3. The lead holding apparatus of claim 1, wherein the lead holding apparatus is adapted to be mounted on a chassis of an electronic device.

4. The lead holding apparatus of claim 1, wherein the lead holding apparatus is integrally formed on a chassis of an electronic device.

5. The lead holding apparatus of claim 1, wherein the size of the groove is determined by one or more diameters and a quantity of the leads.
